(19) United States
(12) Patent Application Publication
(10) Pub. No.: US 2024/0199954 A1
(43) Pub. Date: Jun. 20, 2024

(54) OXIDATION INHIBITOR, OXIDATION INHIBITORY ACTIVITY ENHANCING AGENT, OXIDATION INHIBITION METHOD AND METHOD FOR ENHANCING OXIDATION INHIBITORY ACTIVITY

(71) Applicant: TOHOKU UNIVERSITY, Sendai-shi, Miyagi (JP)

(72) Inventors: Atsushi TAKAHASHI, Sendai-shi, Miyagi (JP); Suguru KATORI, Sendai-shi, Miyagi (JP); Kousuke HIROMORI, Sendai-shi, Miyagi (JP); Naomi KITAKAWA, Sendai-shi, Miyagi (JP)

(73) Assignee: TOHOKU UNIVERSITY, Sendai-shi, Miyagi (JP)

(21) Appl. No.: 18/287,162

(22) PCT Filed: Feb. 21, 2022
(86) PCT No.: PCT/JP2022/006878

§ 371 Date: Oct. 16, 2023

(30) Foreign Application Priority Data
Jun. 15, 2021 (JP) 2021-099623

(51) Int. Cl. C09K 15/18

(52) U.S. Cl. CPC C09K 15/18

(57) ABSTRACT

An oxidation inhibitor which contains a polyalkylene imine compound as an active ingredient; an oxidation inhibitory activity enhancing agent which contains a polyalkylene imine compound as an active ingredient; an oxidation inhibition method which includes making a polyalkylene imine compound and an oxidation inhibiting substance coexist in an oxidation inhibition object; and a method for enhancing oxidation inhibitory activity of an oxidation inhibiting substance, which includes making a polyalkylene imine compound and an oxidation inhibiting substance coexist.

### TECHNICAL FIELD

The present invention relates to an oxidation inhibitor, an oxidation inhibitory activity enhancing agent, an oxidation inhibition method, and a method for enhancing oxidation inhibitory activity.

### BACKGROUND ART

The oxidation of lipids, such as a food oil has been recognized problematic in the field of processing and storing since long ago. This is why the unsaturated fatty acid component constituting a lipid undergoes a radical chain oxidation reaction through a lipid peroxy radical, so that a peroxide is generated, and secondarily, a carbonyl compound such as an aldehyde is generated, thereby causing an odor smell or exhibiting toxicity. Associated with the recent increase in health consciousness, a food oil called a functional oil is strongly concerned. Especially, rice oil which is rich in an omega-6 series fatty acid component and also rich in a phenolic antioxidative component, linseed oil and perilla seed oil which are rich in an omega-3 series fatty acid component, and the like, attract high degree of attention from the viewpoint of the prevention of lifestyle-related diseases or the like. These food oils contain a large amount of an unsaturated fatty acid component as a constituent fatty acid, and therefore, the oxidation deterioration proceeds quickly, and it is difficult to store them stably over a long period. Furthermore, it is pointed out that health risks might be caused by the chemical substances generated through the oxidation deterioration, and therefore, it is desired to provide a measure of effectively inhibiting a lipid containing an unsaturated fatty acid component (unsaturated lipid) from being oxidized.

It is known that the radical chain oxidation reaction of an unsaturated lipid proceeds as follows. First, through an initiation reaction where an unsaturated lipid (LH) and oxygen (O₂) react with each other, a lipid peroxy radical (LOO·) having a high reactivity is generated. This reaction is expressed as follows.

LH+O₂→L·+HO₂

L·+O₂→LOO·

The generated LOO· reacts with an unsaturated lipid to thereby generate a lipid peroxide (LOOH).

LOO·+LH→L·+LOOH

Thus, the oxidation of the lipid proceeds in a chain reaction, thereby causing the rapid generation of the lipid peroxide.

For inhibiting the above chain oxidation reaction, it has been recognized as effective to add a compound having a phenolic hydroxy group (phenolic compound). The phenolic compound captures the lipid peroxy radical so that the phenolic compound per se becomes a stable radical, thereby inhibiting the oxidation of the lipid. The reaction is described below, taking vitamin E (V_{E}H) which is often used as an oxidation inhibitor as an example.

V_{E}H+LOO·→V_{E}·+LOOH

For inhibiting the oxidation of a fish oil which is a highly unsaturated lipid, it is proposed to use spermine which is a natural polyamine compound (NPL 1). NPL 1 indicates that spermine is effective in inhibiting a fish oil from being oxidized, and with respect to the activity of inhibiting the oxidation, spermine solely does not act on the lipid instantly but act thereon concertedly with tocopherol (vitamin E) contained originally in the fish oil to accelerate the oxidation inhibitory activity to the oxidation of the fish oil.

### CITATION LIST

### Non Patent Literature

NPL 1: Journal of Japan Oil Chemists' Society, vol. 45, 12, pp. 1327-1332 (1996)

### SUMMARY OF INVENTION

### Technical Problem

A polyamine compound such as spermine has a peculiar odor, and therefore, in the case of mixing the same in a food oil, the use amount or the like is limited. Furthermore, the polyamine compound is comparatively expensive, and therefore, the general-purpose use is also limited in terms of cost.

An object to be achieved by the present invention is to provide an oxidation inhibitor, an oxidation inhibitory activity enhancing agent, an oxidation inhibition method, and a method for enhancing oxidation inhibitory activity, while realizing an excellent oxidation inhibitory activity, hardly causing a problem of an odor, and being advantageous in cost.

The above object of the present invention is achieved by the following means.

<1> An oxidation inhibitor containing a polyalkylene imine compound as an active ingredient.

<2> The oxidation inhibitor as described in <1>, containing an oxidation inhibiting substance.
<3> The oxidation inhibitor as described in <1>, which is to be used in the coexistence of an oxidation inhibiting substance.
<4> The oxidation inhibitor as described in <2> or <3>, wherein the oxidation inhibiting substance contains a phenolic compound.
<5> The oxidation inhibitor as described in any of <1> to <4>, which inhibits an oxidation of an unsaturated lipid
<6> An oxidation inhibitory activity enhancing agent containing a polyalkylene imine compound as an active ingredient.
<7> The oxidation inhibitory activity enhancing agent as described in <6>, which is to be used in the coexistence of an oxidation inhibiting substance.
<8> A method of inhibiting an oxidation, including making a polyalkylene imine compound and an oxidation inhibiting substance coexist in an object to be inhibited from being oxidized (hereinafter referred to as “oxidation inhibition object”).
<9> A method of enhancing an oxidation inhibitory activity of an oxidation inhibiting substance, including making a polyalkylene imine compound and an oxidation inhibiting substance coexist.
<10> A method of storing an oxidation inhibition object, including storing an oxidation inhibition object in the presence of a polyalkylene imine compound.
<11> A method of storing an oxidation inhibition object as described in <10>, including storing the oxidation inhibition object in the co-existence of an oxidation inhibiting substance.
<12> An oxidation inhibiting material, including a polyalkylene imine compound fixed on a base material.
<13> The oxidation inhibiting material as described in claim 12, which is to be used in the co-existence of an oxidation inhibiting substance.
<14> An oxidation inhibitory activity enhancing material, including a polyalkylene imine compound fixed on a base material.
<15> The oxidation inhibitory activity enhancing material as described in <14>, which is to be used in the co-existence of an oxidation inhibiting substance.
<16> A container for storing an oxidation inhibition object, including a polyalkylene imine compound fixed on at least part of an inside wall of a container.

### Advantageous Effects of Invention

An oxidation inhibitor, an oxidation inhibitory activity enhancing agent, an oxidation inhibition method, and a method for enhancing oxidation inhibitory activity, according to the present invention, realize an excellent oxidation inhibitory activity, hardly cause a problem of an odor, and are advantageous in cost.

### BRIEF DESCRIPTION OF DRAWINGS

FIG. 1 is an explanatory drawing showing one example of a continuous oxidation inhibiting mechanism of an unsaturated lipid according to the oxidation inhibitor of the present invention.

FIG. 2 is a schematic drawing of a Rancimat apparatus.

FIG. 3 is a graph showing an influence of the molecular weight of the polyethylene imine on the oxidation inhibitory activity.

FIG. 4 is a graph showing an influence of the applied amount of the polyethylene imine on the oxidation inhibitory activity and an influence of α-tocopherol on the oxidation inhibitory activity.

FIG. 5 is an explanatory drawing explaining about a method of determining the length of an induction period (IP) which is a period of inhibiting the oxidation.

FIG. 6 is a graph where the relation of the IP of the polyethylene imine and the number of the secondary amino group (—NH—) is plotted.

FIG. 7 is a graph showing the relation of the polyethylene imine, the α-tocopherol concentration, and the IP.

FIG. 8 is a graph showing an oxidation inhibitory activity of the polyethylene imine on grape seed oil in the co-existence of α-tocopherol.

FIG. 9 is a graph showing an oxidation inhibitory activity of the polyethylene imine on perilla seed oil in the co-existence or the non-existence of α-tocopherol.

### DESCRIPTION OF EMBODIMENTS

In the following, preferred embodiments of the present invention are described, but the present invention should not be interpreted as being limited to the following embodiments, the action mechanism, or the like except those defined according to the present invention.

### [Oxidation Inhibitor]

The oxidation inhibitor of the present invention contains a polyalkylene imine compound as an active ingredient. The oxidation inhibition object, which the oxidation inhibitor is used for, is not limited particularly, and for example, those liable to undergo the oxidation deterioration by radicals are suitable as the oxidation inhibition object. As the main action mechanism of the polyalkylene imine compound which is an active ingredient of the oxidation inhibitor of the present invention, it can be considered that, in the co-existence of a substance which directly acts on the oxidation inhibition object and exhibits an effect of inhibiting the oxidation (oxidation inhibiting substance), the polyalkylene imine compound enhances the oxidation inhibitory activity of the oxidation inhibiting substance. However, the action mechanism is not limited the above, as long as the oxidation inhibitor of the present invention, i.e., the polyalkylene imine compound, takes part in inhibiting the oxidation of the oxidation inhibition object.

Preferred embodiments of the oxidation inhibitor of the present invention are described in detail below.

### <Polyalkylene Imine Compound>

A polyalkylene imine is a polymer or an oligomer having a main chain constituted of an alkylene group and an imino group. The polyalkylene imine may be a linear chain, and it is also preferred for the polyalkylene imine to have a branched structure. The polyalkylene imine can be obtained by a ring-opening polymerization of an alkylene imine. In the present invention, the term “polyalkylene imine compound” means including, besides a polyalkylene imine per se, a form formed by substituting one or more but not all of hydrogen atoms thereof, as long as the effects of the present invention are not impaired.

The number of carbon atoms of the alkylene group of the polyalkylene imine compound is preferably an integer of 1 to 10, more preferably an integer of 1 to 6, further preferably an integer of 2 to 4, further preferably 2 or 3. The polyalkylene imine compound preferably includes a polyethylene imine compound, and is more preferably a polyethylene imine compound.

The molecular weight of the polyalkylene imine compound is not limited particularly, and the polyalkylene imine compounds having a molecular weight falling within a wide range, i.e., from a comparatively low molecular weight to a high molecular weight, can be used. As described later, the difference in molecular weight does not substantially influence on the appearance of the effects of the present invention. The molecular weight of the polyalkylene imine compound can be, for example, in terms of an average molecular weight, from 300 to 500000, preferably from 400 to 100000, preferably from 400 to 50000, or preferably from 500 to 30000. The average molecular weight may be 600 or more, 1000 or more, 2000 or more, or 3000 or more. In the present invention or description, the average molecular weight is a number average molecular weight, and is determined as a reduced value in terms of pullulan according to a gel permeation chromatography. With respect to the commercially available products, the molecular weight described in a catalog thereof may be adopted.

The polyalkylene imine compound can be synthesized according to an ordinary method, or can be obtained from the market. Examples of the commercially available product of the polyalkylene imine include EPOMIN (registered trademark, manufactured by Nippon Shokubai Co., Ltd.), LUPASOL (registered trademark, manufactured by BASF), Polyethyleneimine, manufactured by Fujifilm Wako Pure Chemical Corporation), and PEI MAX, manufactured by Polysciences, Inc.

The polyalkylene imines are available at a reagent price of one hundredth of a low molecular amine compound known as exhibiting the oxidation inhibitory activity, such as spermine.

### <Oxidation Inhibition Object>

As the oxidation inhibition object, which is a target for the oxidation inhibitor of the present invention, those liable to undergo an oxidation deterioration by radicals are preferred. Examples thereof include those including one or two or more of an unsaturated lipid (a lipid having an unsaturated fatty acid as a constituent component (an unsaturated fatty acid per se is also employable)), a hydrocarbon, an alcohol, an aldehyde, a ketone, and the like. The oxidation inhibition object is preferably liquid at an ordinary temperature (25° C.). As the oxidation inhibition object, those having such a chemical property that the oxidation is liable to proceed when exposed to air are suitable.

In the present invention, the term “lipid” means including an oil and a fat (glycerides), a compound lipid (phospholipid, glycolipid, and the like), a derived lipid (a fatty acid and the like), and the like. The unsaturated lipid means a lipid including a fatty acid component having an unsaturated bonding (typically, carbon-carbon double bond).

Examples of the fatty acid (unsaturated fatty acid) having an unsaturated bond (typically, carbon-carbon double bond), which is capable of constituting an unsaturated lipid, include an ω (omega)-3 series fatty acid, an ω-6 series fatty acid, an ω-7 series fatty acid, an ω-9 series fatty acid, and an ω-10 series fatty acid. Examples of the unsaturated fatty acid include α-linolenic acid, eicosatetraenoic acid, eicosapentaenoic acid, docosapentaenoic acid, docosahexaenoic acid, linoleic acid, γ-linolenic acid, arachidonic acid, docosatetraenoic acid, docosapentaenoic acid, palmitoleic acid, vaccenic acid, paullinic acid, oleic acid, elaidic acid, erucic acid, nervonic acid, and sapienic acid.

The unsaturated lipid is known to undergo a radical chain oxidation reaction when exposed to air as described above, and those containing the unsaturated lipid are preferred as the oxidation inhibition object. In the case where the oxidation inhibition object contains the unsaturated lipid, the proportion occupied by the unsaturated fatty acid with respect to the total amount of the constituent fatty acids which constitute the unsaturated lipid is preferably 20% by mass or more, more preferably 30% by mass or more, also preferably 40% by mass or more, also preferably 50% by mass or more, also preferably 60% by mass or more, also preferably 70% by mass or more, and also preferably 80% by mass or more. The proportion may be 100% by mass, generally 99% by mass or less, also preferably 95% by mass or less.

In the case where the oxidation inhibition object contains the unsaturated lipid, the unsaturated lipid preferably includes, as the constituent fatty acid, one or two or more of the above-described, α-linolenic acid, eicosatetraenoic acid, eicosapentaenoic acid, docosapentaenoic acid, docosahexaenoic acid, linoleic acid, Y-linolenic acid, arachidonic acid, docosatetraenoic acid, docosapentaenoic acid, palmitoleic acid, vaccenic acid, paullinic acid, oleic acid, elaidic acid, erucic acid, nervonic acid and sapienic acid, more preferably includes one or two or more of oleic acid, linoleic acid, α-linolenic acid, arachidonic acid, eicosapentaenoic acid, and docosahexaenoic acid, and preferably includes one or two or more of α-linolenic acid, arachidonic acid, eicosapentaenoic acid, and docosahexaenoic acid.

It is also preferred that the oxidation inhibition object containing an unsaturated lipid is a food oil. Examples of the food oil include perilla seed oil, linseed oil, safflower oil, grape oil, soybean oil, sunflower oil, corn oil, cottonseed oil, sesame oil, rapeseed oil, rice oil, olive oil, palm oil, fish oil, canola oil, perilla oil, chia seed oil, sacha inchi oil, and rose hip oil. A mixed oil containing one or two or more of these oils may be used. As the oxidation inhibition object, a lipid having a constituent fatty acid composition modified artificially according to an ester exchange reaction or the like and a lipid prepared artificially according to an esterification between an alcohol such as glycerin and a fatty acid are preferred.

Furthermore, a phospholipid having the unsaturated fatty acid as the constituent fatty acid is also preferred as the oxidation inhibition object.

The oxidation inhibition object preferably contains an oxidation inhibiting substance. For example, vitamin E, which is known as the oxidation inhibiting substance, is included in various food oils. By making such a food oil and the oxidation inhibitor of the present invention coexist, vitamin E per se is oxidized to become a radical, and the radical extracts a hydrogen from the polyalkylene imine compound, thereby regenerating vitamin E as an oxidation inhibiting substance. As the result, it is possible for vitamin E to exhibit the oxidation inhibitory activity continuously.

### <Oxidation Inhibiting Substance>

As described above, the oxidation inhibitor of the present invention can enhance the activity of inhibiting the oxidation of the oxidation inhibition object in the co-existence of an oxidation inhibiting substance. The oxidation inhibiting substance inhibits an oxidation of the oxidation inhibition object, generally by being oxidized itself to prevent an oxidation of the oxidation inhibition object or being oxidized itself to reduce an oxidized product of the oxidation inhibition object. As the oxidation inhibiting substance, a compound capable of capturing a radical is preferred. Examples of such a compound include a phenolic compound, carotenoid, an ascorbic acid compound (including a form of a salt thereof), and a thiol compound, and one or two or more thereof can be used. Among them, the oxidation inhibiting substance preferably contains a phenolic compound, and the phenolic compound is not limited particularly as long as it is a compound having a phenolic hydroxy group. Examples thereof include vitamin E (tocopherol or tocotrienol), oryzanol, hydroquinone, butylhydroxyanisole, dibutylhydroxytoluene, butylhydroquinone, resveratrol, quercetin, ferulic acid, and catechin. One or two or more of them may be used as the phenolic compound.

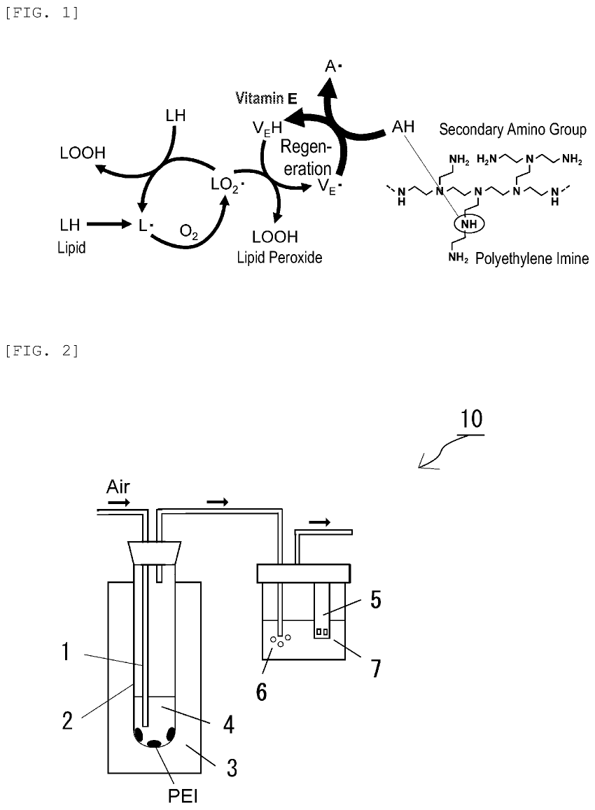

Taking the case where the oxidation inhibition object contains an unsaturated lipid and further contains vitamin E (or vitamin E is added separately) which is an oxidation inhibiting substance as an example, FIG. 1 shows a continuous oxidation inhibiting mechanism of an unsaturated lipid by making the oxidation inhibitor of the present invention act on the oxidation inhibition object. FIG. 1 shows an example where polyethylene imine (PEI, designated as AH in FIG. 1) is used as an active ingredient of the oxidation inhibitor of the present invention. Incidentally, those shown in FIG. 1 are based on some assumption, and the present invention is not limited to the mechanism shown in FIG. 1 except for those defined according to the present invention.

As shown in FIG. 1, in the continuous oxidation reaction of the unsaturated lipid, vitamin E (V_{E}H) acts on the lipid peroxy radical (LO₂·) so that vitamin E is oxidized to thereby become a stable radical (V_{E}·), whereby the oxidation of the unsaturated lipid (the generation of lipid peroxide) is inhibited. However, after vitamin E all is oxidized, the oxidation inhibitory activity cannot be exhibited, and rapid generation of the lipid peroxide is caused. The polyethylene imine is considered to act on the radical (V_{E}·) of vitamin E so that a hydrogen atom is removed from group of the polyethylene imine and the polyethylene imine per se becomes a radical (A·), thereby reducing vitamin E (V_{E}· is returned to V_{E}H) to recover a function as an oxidation inhibiting substance of vitamin E.

The above is an embodiment, and also in the embodiment where the oxidation inhibition object contains the oxidation inhibiting substance other than vitamin E (for example, the above-described phenolic compound other than vitamin E), the polyethylene imine can exhibit the oxidation inhibitory activity in the same action mechanism.

According to one application form of the oxidation inhibitor of the present invention, by adding the oxidation inhibitor of the present invention in the t oxidation inhibition object, fixing the oxidation inhibitor of the present invention on an inside wall of a container for storing an oxidation inhibition object to provide a state where the oxidation inhibitor of the present invention contacts the oxidation inhibition object, or charging a material including a base material having the oxidation inhibitor of the present invention fixed thereon into an oxidation inhibition object, an oxidation inhibition object and the polyalkylene imine compound are made to coexist, so that an oxidation inhibiting substance originally included in the oxidation inhibition object and the polyalkylene imine compound included in the oxidation inhibitor of the present invention act concertedly on the oxidation inhibition object, whereby a form of exhibiting an oxidation inhibiting effect to the oxidation inhibition object can be provided.

Further, according to another application form of the oxidation inhibitor of the present invention, by adding the oxidation inhibitor of the present invention in the oxidation inhibition object, fixing the oxidation inhibitor of the present invention on an inside wall of a container for storing an oxidation inhibition object to provide a state where the oxidation inhibitor of the present invention contacts the oxidation inhibition object, or charging a material including a base material having the oxidation inhibitor of the present invention fixed thereon into an oxidation inhibition object, an oxidation inhibition object and the polyalkylene imine compound included in the oxidation inhibitor of the present invention are made to coexist, and an oxidation inhibiting substance is added in the oxidation inhibition object, separately from the oxidation inhibitor of the present invention, so that the polyalkylene imine compound and the oxidation inhibiting substance act concertedly on the oxidation inhibition object, whereby a form of exhibiting an oxidation inhibiting effect to the oxidation inhibition object can be provided.

In the respective application forms of the oxidation inhibitor of the present invention, with respect to the amount ratio between the polyalkylene imine compound and the oxidation inhibiting substance, for example, the polyalkylene imine compound/the oxidation inhibiting substance (ratio by mass) can be 1/10 to 1000/1, also preferably 1/5 to 500/1, also preferably 1/3 to 100/1, also preferably 1/1 to 25/1.

In the respective application forms of the oxidation inhibitor of the present invention, with respect to the amount ratio between the oxidation inhibition object and the polyalkylene imine compound, for example, the oxidation inhibition object/the polyalkylene imine compound (ratio by mass) can be 10/1 to 10000/1, also preferably 50/1 to 5000/1, also preferably 100/1 to 3000/1, also preferably 300/1 to 1000/1.

As one form of the oxidation inhibitor of the present invention, there is a form where the oxidation inhibitor of the present invention per se contains an oxidation inhibiting substance, besides the polyalkylene imine compound. In this form of the oxidation inhibitor, by adding the oxidation inhibitor of the present invention in the oxidation inhibition object, even if the oxidation inhibition object does not include the oxidation inhibiting substance, a state where the polyalkylene imine compound and the oxidation inhibiting substance coexist in the oxidation inhibition object can be provided. In this case, the respective contents of the polyalkylene imine compound and the oxidation inhibiting substance can be set appropriately according to the purpose. For example, the polyalkylene imine compound/the oxidation inhibiting substance (ratio by mass) can be 1/10 to 1000/1, also preferably 1/5 to 500/1, also preferably 1/3 to 100/1, also preferably 1/1 to 25/1.

With respect to the oxidation inhibitor of the present invention, a form composed of the polyalkylene imine compound, or a form composed of the polyalkylene imine compound and the oxidation inhibiting substance as described above may be applicable. Further, besides the polyalkylene imine compound or the oxidation inhibiting substance, a medium or various additives may be included appropriately according to the purpose.

The content of the polyalkylene imine compound in the oxidation inhibitor of the present invention can be set appropriately according to the form of the oxidation inhibitor, and for example, is preferably 1% by mass or more, may be 5% by mass or more, may be 10% by mass or more, also preferably 30% by mass or more, also preferably 50% by mass or more, also preferably 70% by mass or more. With respect to the oxidation inhibitor of the present invention, a form composed of the polyalkylene imine compound may be applicable. With respect to the oxidation inhibitor of the present invention, a form where the above-described oxidation inhibiting substance, a medium such as a solvent, various additives or the like is appropriately included according to the purpose as the remainder other than the polyalkylene imine compound may be applicable.

The polyalkylene imine compound is a polymer having a high viscosity, and is hard to dissolve in an unsaturated lipid or the like. Therefore, the polyalkylene imine compound is fixed on a base material to enable the form of the polyalkylene imine compound contacting the oxidation inhibition object at the fixed state. The fixing can be performed by applying the oxidation inhibitor of the present invention on a base material or chemically fixing the component of the oxidation inhibitor of the present invention on a base material.

The oxidation inhibitor of the present invention may be present in a form of a composition where the respective components are mixed homogeneously or a form where the respective components are mixed heterogeneously. Further, the polyalkylene imine compound and the other components (for example, the oxidation inhibiting substance) are packed separately, and a form where the respective components are more separated (so-called oxidation inhibitor set) may be applicable. The form of the set may be a form where the respective components separated for constituting the oxidation inhibitor may be mixed at use, or may be added to or brought into contact with the oxidation inhibition object, at the same time or with time difference.

### [Oxidation Inhibitory Activity Enhancing Agent]

The oxidation inhibitory activity enhancing agent of the present contains the polyalkylene imine compound as an active ingredient, and is an agent for acting on the oxidation inhibiting substance to thereby enhance the oxidation inhibitory activity of the oxidation inhibiting substance. In the description of the oxidation inhibitory activity enhancing agent of the present invention, the polyalkylene imine compound, the oxidation inhibition object, and the oxidation inhibiting substance have the same meanings as the polyalkylene imine compound, the oxidation inhibition object, and the oxidation inhibiting substance which are described in the item of the oxidation inhibitor of the present invention, respectively.

The oxidation inhibitory activity enhancing agent of the present invention is different from the oxidation inhibitor of the present invention in the point of not containing the oxidation inhibiting substance, and with respect to the other points (shape of the agent, application form), those described with respect to the oxidation inhibitor of the present invention are applicable. That is, the oxidation inhibitory activity enhancing agent of the present invention is applicable to the oxidation inhibition object which already contains the oxidation inhibiting substance or the oxidation inhibition object which is planned to be mixed with the oxidation inhibiting substance.

Furthermore, after the oxidation inhibitory activity enhancing agent of the present invention is mixed with the oxidation inhibiting substance, the resultant oxidation inhibitory activity enhancing agent may be made to act on the oxidation inhibition object. By adding the oxidation inhibitory activity enhancing agent of the present invention in the oxidation inhibition object, fixing the oxidation inhibitory activity enhancing agent of the present invention on an inside wall of a container for storing an oxidation inhibition object to provide a state where the oxidation inhibitory activity enhancing agent of the present invention contacts the oxidation inhibition object, or charging a material including a base material having the oxidation inhibitory activity enhancing agent of the present invention fixed thereon into an oxidation inhibition object, the polyalkylene imine compound and the oxidation inhibiting substance are made to act concertedly on the oxidation inhibition object, thus making it possible to effectively enhance the oxidation inhibitory activity of the oxidation inhibiting substance on the oxidation inhibition object.

In the respective application forms of the oxidation inhibitory activity enhancing agent of the present invention, with respect to the amount ratio between the polyalkylene imine compound and the oxidation inhibiting substance, for example, the polyalkylene imine compound/the oxidation inhibiting substance (ratio by mass) can be 1/10 to 1000/1, also preferably 1/5 to 500/1, also preferably 1/3 to 100/1, also preferably 1/1 to 25/1.

In the respective application forms of the oxidation inhibitory activity enhancing agent of the present invention, with respect to the amount ratio between the oxidation inhibition object and the polyalkylene imine compound, for example, the oxidation inhibition object/the oxidation inhibiting substance (ratio by mass) can be 10/1 to 10000/1, also preferably 50/1 to 5000/1, also preferably 100/1 to 3000/1, also preferably 300/1 to 1000/1.

The content of the polyalkylene imine compound in the oxidation inhibitory activity enhancing agent of the present invention can be set appropriately according to the form of the oxidation inhibitory activity enhancing agent, and for example, is preferably 1% by mass or more, may be 5% by mass or more, may be 10% by mass or more, also preferably 30% by mass or more, also preferably 50% by mass or more, also preferably 70% by mass or more, also preferably 80% by mass or more, also preferably 90% by mass or more. With respect to the oxidation inhibitory activity enhancing agent of the present invention, a form composed of the polyalkylene imine compound may be applicable. With respect to the oxidation inhibitory activity enhancing agent of the present invention, a form appropriately including a medium such as a solvent, various additives or the like as the remainder other than the polyalkylene imine compound may be applicable.

### [Oxidation Inhibition Method]

The method of inhibiting an oxidation includes making the polyalkylene imine compound and the oxidation inhibiting substance coexist in the oxidation inhibition object. That is, the method includes making the polyalkylene imine compound and the oxidation inhibiting substance coexist in the oxidation inhibition object, thereby making the polyalkylene imine compound and the oxidation inhibiting substance act on the oxidation inhibition object concertedly, thereby exhibiting the oxidation inhibiting effect on the oxidation inhibition object.

In the description of the method of inhibiting an oxidation of the present invention, the polyalkylene imine compound, the oxidation inhibition object, and the oxidation inhibiting substance have the same meanings as the polyalkylene imine compound, the oxidation inhibition object, and the oxidation inhibiting substance which are described in the item of the oxidation inhibitor of the present invention, respectively.

The embodiment of the method of inhibiting an oxidation is not limited except for those defined in the present invention. In one embodiment of the method of inhibiting an oxidation, the oxidation inhibitor of the present invention can be used as a supply source for the polyalkylene imine compound or the oxidation inhibiting substance. Furthermore, in another embodiment, the oxidation inhibitory activity enhancing agent of the present invention can be used as a supply source for the polyalkylene imine compound.

In the method of inhibiting an oxidation of the present invention, with respect to the amount ratio between the polyalkylene imine compound and the oxidation inhibiting substance to be used, for example, the polyalkylene imine compound/the oxidation inhibiting substance (ratio by mass) can be 1/10 to 1000/1, also preferably 1/5 to 500/1, also preferably 1/3 to 100/1, also preferably 1/1 to 25/1.

In the method of inhibiting an oxidation of the present invention, with respect to the amount ratio between the oxidation inhibition object and the polyalkylene imine compound, for example, the oxidation inhibition object/the polyalkylene imine compound (ratio by mass) can be 10/1 to 10000/1, also preferably 50/1 to 5000/1, also preferably 100/1 to 3000/1, also preferably 300/1 to 1000/1.

### [Method of Enhancing Oxidation Inhibitory Activity]

The method of enhancing an oxidation inhibitory activity of the oxidation inhibiting substance according to the present invention (the method of enhancing an oxidation inhibitory activity of the present invention) includes making the polyalkylene imine compound and the oxidation inhibiting substance coexist. For example, by making the polyalkylene imine compound and the oxidation inhibiting substance coexist in the oxidation inhibition object, the polyalkylene imine compound and the oxidation inhibiting substance are made to act on the oxidation inhibition object concertedly, thereby making it possible to enhance the oxidation inhibitory activity of the oxidation inhibiting substance on the oxidation inhibition object.

In the description of the method of enhancing an oxidation inhibitory activity of the present invention, the polyalkylene imine compound, the oxidation inhibition object, and the oxidation inhibiting substance have the same meanings as the polyalkylene imine compound, the oxidation inhibition object, and the oxidation inhibiting substance which are described in the item of the oxidation inhibitor of the present invention, respectively.

In one embodiment of the method of enhancing an oxidation inhibitory activity of the present invention, the oxidation inhibitor of the present invention can be used as a supply source for the polyalkylene imine compound or the oxidation inhibiting substance. Furthermore, in another embodiment, the oxidation inhibitory activity enhancing agent of the present invention can be used as a supply source for the polyalkylene imine compound.

In the method of enhancing an oxidation inhibitory activity of the present invention, with respect to the amount ratio between the polyalkylene imine compound and the oxidation inhibiting substance to be used, for example, the polyalkylene imine compound/the oxidation inhibiting substance (ratio by mass) can be 1/10 to 1000/1, also preferably 1/5 to 500/1, also preferably 1/3 to 100/1, also preferably 1/1 to 25/1.

In the method of enhancing an oxidation inhibitory activity of the present invention, with respect to the amount ratio between the oxidation inhibition object and the polyalkylene imine compound, for example, the oxidation inhibition object/the polyalkylene imine compound (ratio by mass) can be 10/1 to 10000/1, also preferably 50/1 to 5000/1, also preferably 100/1 to 3000/1, also preferably 300/1 to 1000/1.

The method of inhibiting an oxidation, the oxidation inhibitory activity enhancing agent, the method of inhibiting an oxidation, and the method of enhancing oxidation inhibitory activity are applicable to the case where the oxidation inhibition object is stored in a container or the like, and further, the case where a living body (including humans, a mammal (livestock, pets, and the like) other than humans, and the other vertebrate animals) takes in a functional oil or the like to effectively exhibit the bioactivity of the functional oil in the living body. For example, by taking in the oxidation inhibitor or the oxidation inhibitory activity enhancing agent of the present invention, along with taking in perilla seed oil including α-linolenic acid as the constituent fatty acid in a large amount, which attracts attention as a functional oil, or the like, the oxidation of the unsaturated lipids included in perilla seed oil in a digestive canal and the like is inhibited, and the bioactivity can be exhibited effectively. When the oxidation inhibitor or the oxidation inhibitory activity enhancing agent of the present invention is taken in, the effect of inhibiting the oxidation of the unsaturated lipids present in the living body (for example, phospholipid which is a cell membrane component) can be expected.

With respect to the above-described embodiments, the invention described below is further provided based on the present invention.

(1) A method of storing an oxidation inhibition object, which includes storing an oxidation inhibition object in the presence of a polyalkylene imine compound.
(2) The method of storing an oxidation inhibition object as described in (1), which is performed in the coexistence of an oxidation inhibiting substance.
(3) The method of storing an oxidation inhibition object as described in (1) or (2), in which the oxidation inhibition object contains an unsaturated lipid.
(4) The method of storing an oxidation inhibition object as described in any of (1) to (3), in which the oxidation inhibition object is a food oil.
(5) An oxidation inhibiting material, including a polyalkylene imine compound fixed on a base material.
(6) The oxidation inhibiting material as described in (5), which is to be used in the co-existence of an oxidation inhibiting substance.
(7) An oxidation inhibitory activity enhancing material, including a polyalkylene imine compound fixed on a base material.
(8) The oxidation inhibitory activity enhancing material as described in (7), which is to be used in the co-existence of an oxidation inhibiting substance.
(9) A container for storing an oxidation inhibition object, including a polyalkylene imine compound fixed on at least part of an inside wall of a container.
(10) The container for storing an oxidation inhibition object as described in (9), in which the oxidation inhibition object contains an unsaturated lipid.
(11) The container for storing an oxidation inhibition object as described in (9) or (10), in which the oxidation inhibition object is a food oil.

### EXAMPLES

The present invention is described in more detail based on examples, and the present invention should not be understood by limitation to the forms of examples except those defined in the present invention.

### [Test-1 of Inhibiting Oxidation of Unsaturated Lipid]

### <Materials>

As a model of an unsaturated lipid, methyl linoleate (concentration: 95% by mass, manufactured by Tokyo Chemical Industry Co., Ltd.) was used. Since the methyl group does not influence on an oxidation of a fatty acid group, methyl linoleate is considered to be appropriate as a model of an unsaturated lipid.

As the oxidation inhibiting substance, α-tocopherol (Wako 1st Grade, manufactured by Fujifilm Wako Pure Chemical Corporation), which is vitamin E, was used.

As the polyalkylene imine compound, polyethylene imines having different molecular weights (manufactured by Fujifilm Wako Pure Chemical Corporation) were provided. One is a polyethylene imine having an average molecular weight of 10000, and an amino group composition of the primary group (—NH₂) of 35 mol %, the secondary group (—NH—) of 35 mol %, and the tertiary group (—N(—)—) of 30 mol %, and the other is a polyethylene imine having an average molecular weight of 600, and an amino group composition of the primary group of 35 mol %, the secondary group of 35 mol %, and the tertiary group of 30 mol %. Incidentally, for convenience in the present description, an unsubstituted amino group, a monosubstituted amino group, and a disubstituted amino group are referred to as a primary amino group, a secondary amino group, and a tertiary amino group, respectively.

### <Test Method>

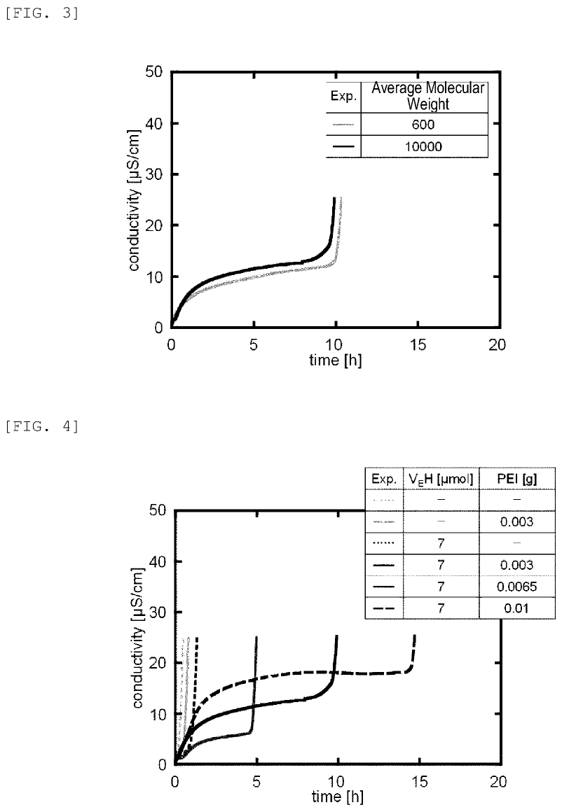

The Rancimat test was performed. FIG. 2 is a schematic drawing of a Rancimat apparatus (743 Rancimat, Metrohm AG, Switzerland). The Rancimat apparatus 10 includes a reaction part including a nozzle for supplying air 1, a reaction tube 2, on the bottom of which polyethylene imine (PEI) was applied, and a block heater 3 for controlling the temperature, and a measurement part equipped with a conductivity cell 5. In the reaction part, specimen 4 (3.0 g of methyl linoleate and 7.0 μmol of α-tocopherol) put in the reaction tube 2 was held at 120° C., and air was introduced into the specimen 4 at a flow rate of 20 L/h, so that the oxidation of the specimen 4 was forced to proceed. In the measurement part, volatile oxidation product 6 generated by the oxidation was collected in pure water 7, and the conductivity was measured to evaluate the rate of progression of the oxidation.

With respect to the applied amount of the polyethylene imine onto the bottom of the reaction tube 2, three kinds of 0.003 g (3 mg), 0.0065 g (6.5 mg), and 0.01 g (10 mg) were provided for comparison. Incidentally, in order that the results are not affected by the application forms, polyethylene imine was applied at a spotted state of 10 or more of dots (In FIG. 2, only three dots among 10 or more of dots are shown, as FIG. 2 is a schematically explanatory drawing).

### <Influence of Molecular Weight of Polyethylene Imine>

Polyethylene imines having an average molecular weight of 600 and 10000 each was applied on the bottom of the reaction tube 2 at a spotted sate such that the applied amount was 0.0065 g, and the Rancimat test was performed under the above conditions. The results are shown in FIG. 3.

As shown in FIG. 3, there appeared to be almost no difference in the change in conductivity with the lapse of time. From the results, it was judged that influence in inhibiting the oxidation by the molecular weight of the polyethylene imine did not present substantially. Therefore, the following tests were performed by using a polyethylene imine having an average molecular weight of 10000.

### <Influence of Applied Amount of Polyethylene Imine>

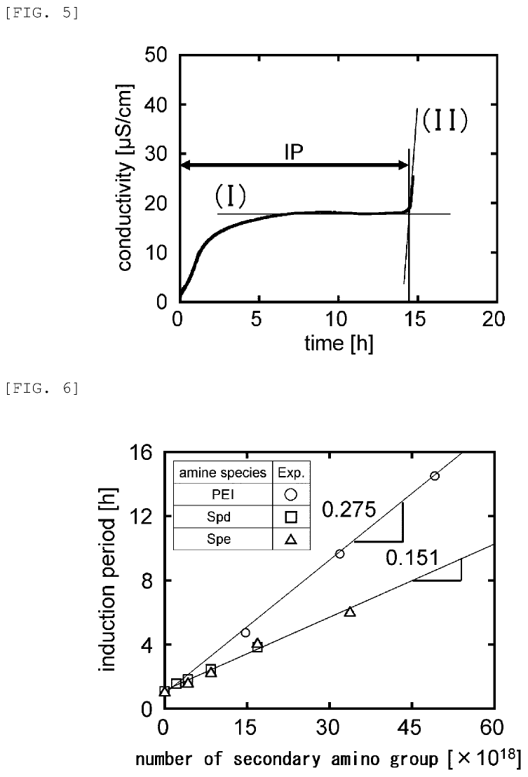

The influence of the applied amount of the polyethylene imine was verified by performing the Rancimat test under the above conditions. For reference, the specimen not containing α-tocopherol was also subjected to the Rancimat test. The results are shown in FIG. 4.

As shown in FIG. 4, in the case where the specimen did not contain α-tocopherol (V_{E}H), the effect of inhibiting the oxidation was not recognized. That is, it was not recognized that the polyethylene imine (PE1) directly caused the effect of inhibiting the oxidation of the specimen. Furthermore, in the case where the specimen contained α-tocopherol, but the polyethylene imine did not coexist, the time at which the conductivity started to increase vertically delayed only a little, and thus, the effect of inhibiting the oxidation was considerably limited.

On the other hand, in the cases where α-tocopherol and the polyethylene imine were made to coexist in the specimen, it can be seen that the time at which the conductivity started to increase vertically delayed largely. Incidentally, the delay effect (oxidation inhibitory activity) was enhanced in proportion to the applied amount of the polyethylene imine.

From the above results, it can be seen that the polyethylene imine exhibits the effect of rapidly enhancing the oxidation inhibiting effect in the coexistence of the oxidation inhibiting substance such as α-tocopherol.

Further, in the cases where the polyethylene imine was added, at an initial period (until about two minutes elapsed) after the initiation of the experiment, a rapid increase in the conductivity was observed. It was confirmed by determining the amount of the peroxides by direct titration that the increase in the conductivity at the initial period was not caused by the oxidation acceleration derived from the polyethylene imine. With respect to the case where the polyethylene imine is used as a CO₂ absorbent, it is known that the polyethylene imine has a characteristic of releasing the absorbed CO₂ at high temperatures. It can be considered as one of the causes of the increase in the conductivity at the initial period that the released CO₂ dissolved in the ultra-pure water to become a carbonate ion.

Concerning the results shown in FIG. 4, the oxidation inhibiting effect of the polyethylene imine was evaluated quantitatively. As an index for comparison of the oxidation inhibiting effect, the length of the induction period (IP), which is the period which the oxidation is inhibited during, was determined. Here, the method of determining the length of IP is described below referring to FIG. 5. The graph of FIG. 5 shows the results obtained when the applied amount of the polyethylene imine was 0.01 g (In FIG. 5, they are shown with a solid line, while in FIG. 4, for convenience, they are shown with a broken line). With respect to the interval, which is shown as (I), where the oxidation proceeds slowly, and therefore, the conductivity proceeds slowly, and the interval, which is shown as (II), where the oxidation proceeds rapidly, and therefore, the conductivity increases vertically to reach 25 μS/cm, tangent lines thereto are drawn, respectively, and the time at the intersection point of the tangent lines is defined as the induction period (IP).

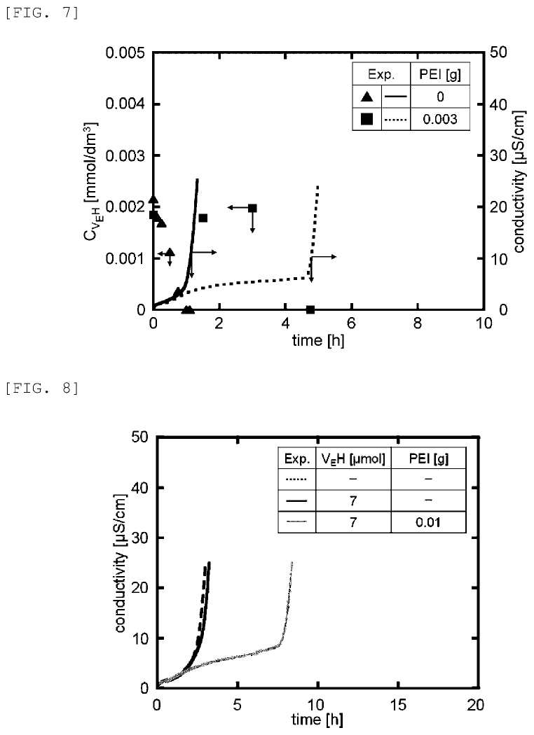

FIG. 6 shows the relation between the IP of the polyethylene imine and the number of the secondary amino group (—NH—) by plotting. For the plot, the number of the secondary amino group (—NH—) was adjusted by the added amount of the polyethylene imine. For comparison, the results of spermine (Spe) and spermidine (Spd), which are a low molecular polyamine compound, are also shown in the figure. From the results of FIG. 6, with respect to the use of each of the polyethylene imine, spermine, and spermidine, the number of the secondary amino group and IP exhibited a linear relation. That worthy of special mention is that the rate (inclination) of the increase of the IP per the secondary amino group of the polyethylene imine is overwhelmingly higher than those of spermine, and spermidine. With respect to the polyethylene imine, some factor attributable to the polymer structure is supposed to raise the oxidation inhibitory activity of α-tocopherol to a remarkably high level.

Thus, by using the polyethylene imine having an inexpensive reagent price, with the use amount being further reduced, it is possible to exhibit an aimed excellent oxidation inhibitory activity.

The above activity of the polyethylene imine resides in that the oxidation inhibitory activity of α-tocopherol is exhibited continuously and at a high efficiency by regenerating α-tocopherol from a radical thereof at a high efficiency. This was verified by capturing the change in the concentration of α-tocopherol in the specimen with a lapse of time.

### <Quantification of α-Tocopherol in Specimen>

For the quantification of α-tocopherol in each specimen, each specimen was diluted with hexane and then filtrated through a 0.2 μm-filter (manufactured by Sartorius Stedim Biotech), and the obtained filtrate was subjected to the measurement by means of a high-speed liquid chromatograph system (manufactured by Waters) provided with a fluorescence detector. As the column, a normal phase BEH HILIC (manufactured by Waters, particle size: 1.6 μm, ϕ2.1 mm×100 mm) was used. As the eluent, a mixed liquid composed of hexane, ethyl acetate and acetic acid in the ratio by volume of 99.5:0.5:0.18 was used. The supply flow rate was 0.7 cm³/min, and the column temperature was 323K. For the analysis, the fluorescence detector was used, and the wavelength of the exciting light was set to 298 nm, and the fluorescent wavelength was set to 325 nm.

FIG. 7 shows the measurement results (▪) of α-tocopherol concentration in the case of using 0.003 g of polyethylene imine. For reference, the change in the conductivity with a lapse of time was also shown. Further, in the case of not adding the polyethylene imine, the measurement results (▴) of α-tocopherol concentration and the change in the conductivity with a lapse of time are also shown. In the case of not adding the polyethylene imine, it can be seen that the α-tocopherol concentration decreased rapidly with a lapse of time, and after the consumption of α-tocopherol, the oxidation proceeded rapidly. On the other hand, in the case of adding the polyethylene imine, the α-tocopherol concentration was almost the same during the prolonged IP period. This indicates that the polyethylene imine per se is oxidized, and the resultant reduces the oxidized α-tocopherol to regenerate α-tocopherol, and thus, the oxidation inhibitory activity of α-tocopherol is exhibited continuously to achieve the prolonged oxidation inhibiting effect.

### [Test-2 of Inhibiting Oxidation of Unsaturated Lipid]

The oxidation inhibiting effect of the polyethylene imine on the actual food oil was investigated.

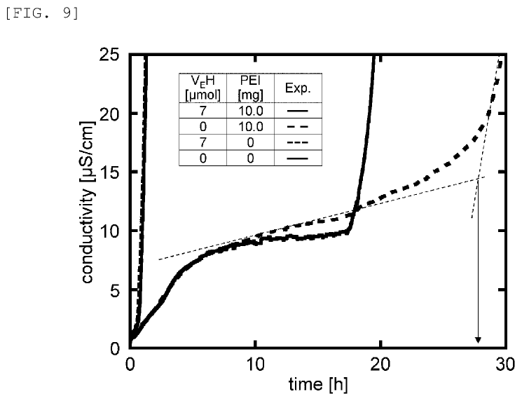

FIG. 8 shows the change in the conductivity with a lapse of time in the case of adding the polyethylene imine to grape seed oil. Between the case of the single use of the grape seed oil, and the case where α-tocopherol was added but the polyethylene imine was not added, the substantial difference in the IP could not be seen. In the case of adding both the polyethylene imine and α-tocopherol, the IP was prolonged about three times. This proved that the polyethylene imine exhibits an oxidation inhibiting effect on a food oil which α-tocopherol is added to. Further, the measurement results with respect to the grape seed oil exhibited the IP shorter than that of the case of using a model-type methyl linoleate under the same addition conditions. The reason is not clear, but there appears to be the possibility that the co-existent substance in the grape seed oil gives an adverse effect on the prolongation of the IP.

Further, FIG. 9 shows the change in the conductivity with a lapse of time in the case of adding the polyethylene imine to perilla seed oil. With respect to the use of perilla seed oil, similarly to the use of the grape seed oil, the substantial difference in the IP could not be seen between the case of the single use of perilla seed oil and the case where α-tocopherol was added but the polyethylene imine was not added, and the oxidation rapidly proceeded. On the other hand, in the adding both the polyethylene imine and α-tocopherol, the IP was prolonged largely. From the above results, it can be seen that the polyethylene imine exhibits an oxidation inhibiting effect on a food oil which α-tocopherol is added to. With respect to the single use of the food oil, perilla seed oil, which is rich in linolenic acid liable to be oxidized, was oxidized more rapidly than grape seed oil. On the other hand, in the case of adding the polyethylene imine and α-tocopherol, perilla seed oil was inhibited from being oxidized more prolongedly. The perilla seed oil often includes a natural oxidation inhibiting substance, so it appears to be a possibility that the polyethylene imine and the antioxidant act concertedly, so that the case of perilla seed oil exhibited a higher oxidation inhibiting effect than the case of the grape seed oil.

Actually, FIG. 9 shows that in the case of not adding α-tocopherol but adding the polyethylene imine to perilla seed oil, a sufficiently prolonged oxidation inhibiting effect is exhibited. The results suggest that, even if α-tocopherol is not added, the oxidation inhibiting substance originally included in perilla seed oil acts concertedly with the polyethylene imine, whereby the oxidation of perilla seed oil is effectively inhibited.

While the present invention is described above referring to the embodiments, we do not intend to limit the present invention to any of the details of the description unless otherwise specifically indicated, and consider that a broad interpretation should be done, without being contrary to the sprits and scopes indicated in the attached claims.

The present application claims a priority based on Japanese Patent Application No. 2021-099623 filed on Jun. 15, 2021, and the contents are incorporated by reference in the present application as part of the present description.

### REFERENCE SIGNS LIST

10: Rancimat apparatus
1: Nozzle for supplying air
2: Reaction tube
3: Block heater
4: Specimen
5: Conductivity cell
6: Volatile oxidation product
7: Pure water

1. An oxidation inhibitor comprising a polyalkylene imine compound as an active ingredient.

2. The oxidation inhibitor according to claim 1, comprising an oxidation inhibiting substance.

3. The oxidation inhibitor according to claim 1, which is to be used in the coexistence of an oxidation inhibiting substance.

4. The oxidation inhibitor according to claim 2, wherein the oxidation inhibiting substance contains a phenolic compound.

5. The oxidation inhibitor according to claim 1, which inhibits an oxidation of an unsaturated lipid.

6. An oxidation inhibitory activity enhancing agent comprising a polyalkylene imine compound as an active ingredient.

7. The oxidation inhibitory activity enhancing agent according to claim 6, which is to be used in the coexistence of an oxidation inhibiting substance.

8. A method of inhibiting an oxidation, comprising making a polyalkylene imine compound and an oxidation inhibiting substance coexist in an oxidation inhibition object.

9. A method of enhancing an oxidation inhibitory activity of an oxidation inhibiting substance, comprising making a polyalkylene imine compound and an oxidation inhibiting substance coexist.

10. A method of storing an oxidation inhibition object, comprising storing an oxidation inhibition object in the presence of a polyalkylene imine compound.

11. A method of storing an oxidation inhibition object according to claim 10, comprising storing the oxidation inhibition object in the co-presence of an oxidation inhibiting substance.

12. An oxidation inhibiting material, comprising a polyalkylene imine compound fixed on a base material.

13. The oxidation inhibiting material according to claim 12, which is to be used in the co-existence of an oxidation inhibiting substance.

14. An oxidation inhibitory activity enhancing material, comprising a polyalkylene imine compound fixed on a base material.

15. The oxidation inhibitory activity enhancing material according to claim 14, which is to be used in the co-existence of an oxidation inhibiting substance.

16. A container for storing an oxidation inhibition object, comprising a polyalkylene imine compound fixed on at least part of an inside wall of a container.

17. The oxidation inhibitor according to claim 3, wherein the oxidation inhibiting substance contains a phenolic compound.
